(19) United States
(12) Patent Application Publication
(10) Pub. No.: US 2016/0077068 A1
(43) Pub. Date: Mar. 17, 2016

(54) THIN-LAYER CHROMATOGRAPHY PLATE, METHOD FOR PRODUCING SUCH A PLATE, AND METHOD FOR PERFORMING A THIN-LAYER CHROMATOGRAPHY SEPARATION

(71) Applicant: MERCK PATENT GMBH, Darmstadt (DE)

(72) Inventor: Michael SCHULZ, Darmstadt (DE)

(73) Assignee: Merck Patent GmbH, Darmstadt (DE)

(21) Appl. No.: 14/784,063

(22) PCT Filed: Mar. 17, 2014
(86) PCT No.: PCT/EP2014/000717

§ 371 Date: Oct. 13, 2015

(30) Foreign Application Priority Data
Apr. 17, 2013 (EP) 13002009.2

(51) Int. Cl. G01N 30/92; G01N 30/95

(52) U.S. Cl. CPC G01N 30/92; G01N 30/95

(57) ABSTRACT

The present invention relates to a thin-layer chromatography plate at least consisting of a support and a sorbent layer, where the sorbent layer comprises at least one siloxane oligomer, to a process for the production thereof, and to a method for carrying out a thin-layer chromatographic separation using said thin-layer chromatography plate.

The present invention relates to a thin-layer chromatography plate in which the binder at the same time carries functional groups, and to a process for the production thereof.

The principle of thin-layer chromatography is known to the person skilled in the art. Typically, small volumes of various solutions comprising the substance mixtures to be separated are applied to the porous thin layer in the form of spots on a starting line. The edge of the support plates below the starting line is then brought into contact with a liquid eluent, where the capillary rise of the eluent in the porous thin layer carries the individual substances along with it. Due to different adsorption or distribution coefficients, the substances are transported at different speeds and thus separated. After removal and drying of the support plates, they are located above the plate as substance zones distributed on lanes, each of which begin at the starting point of the mixtures and run behind the mobile-phase front. It is thus possible to separate, for example, ten to thirty mixtures at the same time on one support plate.

For very complicated mixtures, two-dimensional thin-layer chromatography is also known.

The sorbents or support materials typically used in thin-layer chromatography, for example silica gel or aluminium oxide, have only slight adhesion properties, so that the separation layers produced from them have low mechanical resistance.

For this reason, a binder, which increases the stability and abrasion resistance of the separation layers, is added to the sorbents. These binders are typically organic polymers, as disclosed, for example, in CH 528081 or DE 1598382.

In particular, the use of organic binders (for example high-molecular-weight polyacrylic acids) has become established for the industrial production of thin-layer plates, also called TLC plates. These layers are very stable compared with pure sorbent layers and can consequently be produced and packed without problems.

However, a major disadvantage in the case of the use of binders is that they may impair the separation properties of the TLC plate, for example by covering the surface of the sorbent particles, so that they are no longer sufficiently accessible. In addition, some binders are dissolved on use of certain eluents.

It has therefore hitherto been attempted in thin-layer chromatography to find highly inert binders which exert as little influence as possible on the separation behaviour of the TLC plate.

It has now been found that, in contrast to the highly inert materials to date, binders which bond covalently and contain functional groups by means of which they are able to influence the separation properties of the TLC plate can successfully be employed in thin-layer chromatography. The TLC plate obtained on use of these binders consequently has a separation layer which, besides the actual sorbent, such as, for example, functionalised silica gel, comprises a further sorbent component. This further sorbent component acts on the one hand as binder, in that, like conventional binders, it increases the mechanical stability of the separation layer, and on the other hand additionally acts as sorbent, since it contains functional groups which influence the separation of the sample substances. It has been found that oligo- or polysiloxane derivatives are particularly suitable for these purposes.

The present invention therefore relates to a thin-layer plate at least consisting of a support and a sorbent layer, where the sorbent layer comprises at least one siloxane oligomer.

In a preferred embodiment, the sorbent layer additionally comprises inorganic and/or organic particles, such as SiO₂, for example in the form of silica gel or kieselguhr, Al₂O₃, TiO₂, acrylic/methacrylic-based polymers (for example GM/CGDMA glycidyl methacrylate/ethlene glycol dimethacrylate or HEMA hydroxyethyl metacrylate), polysaccharides (for example cellulose, agarose), hydrophilic polyvinyl ether (for example BDMVE butanediol monovinyl ether or DVH divinylethleneurea) particles, preferably SiO₂ particles.

In a further preferred embodiment, the siloxane oligomer contains C1 to C18 alkyl groups and/or amino groups. Preference is given to a sorbent layer which comprises at least one siloxane oligomer containing C1 to C18 alkyl groups and/or amino groups and inorganic and/or organic particles.

In an embodiment, the siloxane oligomer is a co-condensate of at least two different silanes, preferably a water-soluble silane and a water-insoluble silane, such as, for example, an aminosilane and an alkylsilane. Preference is given to a sorbent layer which comprises at least one siloxane oligomer which is a co-condensate of at least two different silanes, preferably a water-soluble silane and a water-insoluble silane, and inorganic and/or organic particles.

In a preferred embodiment, the thickness of the sorbent layer is between 10 μm and 500 μm.

In an embodiment, the thin-layer plate can be produced by
a) preparation of a mixture at least comprising a siloxane oligomer and a solvent, preferably water
b) application of the mixture from step b) to a support
c) heat treatment or temperature treatment of the thin-layer plate

In an embodiment, the mixture from step a) may also comprise organic and/or inorganic particles.

In a preferred embodiment, step a) is carried out by
a1) preparation of a suspension of inorganic and/or organic particles in a solvent, preferably water
a2) mixing of the suspension from step a) with a siloxane oligomer

The present invention also relates to a process for the production of thin-layer plates by
a) provision of a mixture which comprises at least one siloxane oligomer and a solvent
b) application of the mixture from step a) to a support
c) temperature treatment

In a preferred embodiment, the temperature treatment is carried out by means of a temperature gradient in which the temperature is increased continuously or stepwise, typically from room temperature to a temperature between 50 and 200° C., over a period of between 30 and 200 minutes.

The present invention also relates to a method for carrying out a thin-layer chromatographic separation having the following method steps
a) provision of a thin-layer plate according to the invention
b) application of the samples to the thin-layer plate
c) development of the thin-layer plate using an eluent
d) removal of the eluent
e) evaluation of the thin-layer plate

In a preferred embodiment, the evaluation of the thin-layer plate is carried out by bringing a sorbent layer area to be evaluated into contact with an eluent and feeding the eluate into an evaluation device.

In a preferred embodiment, the evaluation device is a mass spectrometer.

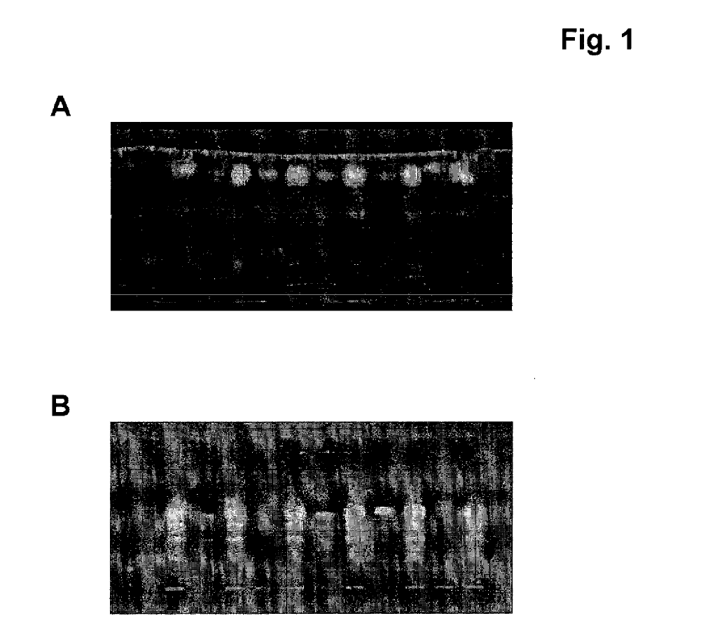

FIG. 1 shows two developed thin-layer plates. Thin-layer plate A was produced by the process described, plate B is a Merck Millipore HPTLC Si60 NH₂ plate. Further details on FIG. 1 can be found in Example 3.

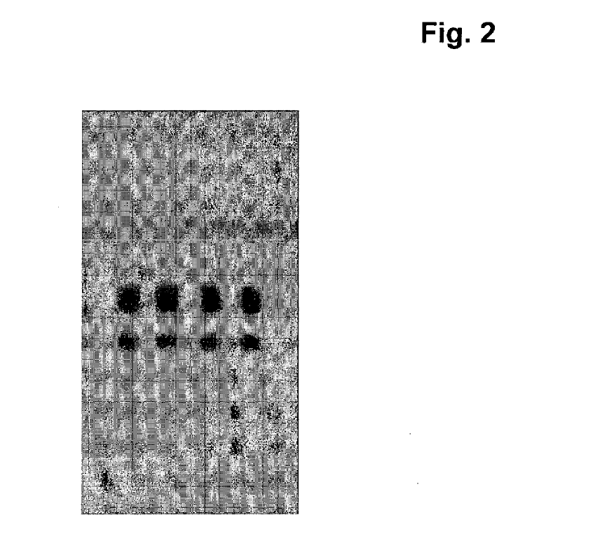

FIG. 2 shows the photograph of a thin-layer plate at UV 254 nm.

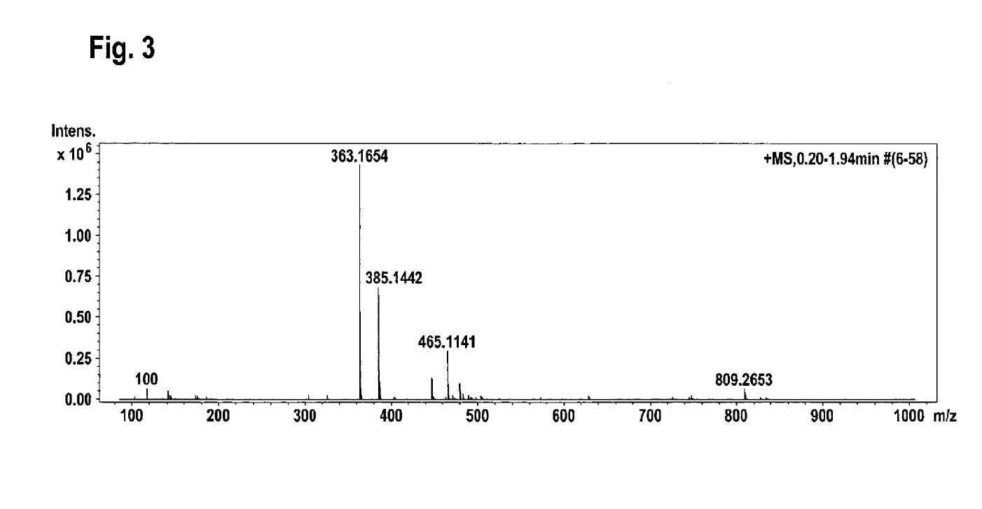

FIG. 3 shows the MS spectrum of hydrocortisone (lower band).

Details on FIGS. 2 and 3 can be found in Example 4.

A thin-layer plate is known to the person skilled in the art. In general, it consists of a support, for example in the form of a glass plate, plastic sheet or aluminium foil, and a sorbent layer.

A sorbent layer is the part of the thin-layer plate in which the chromatographic separation of the sample takes place. A sorbent layer may comprise one or more sorbents. Typical sorbents are SiO₂, aluminium oxide, kieselguhr, silica gel, cellulose or TiO₂. The sorbent layer of the thin-layer plate according to the invention preferably comprises SiO₂, for example in the form of kieselguhr or silica gel.

The sorbents may be in unfunctionalised or functionalised form. The functionalisation of the sorbent serves to establish certain separation properties by the introduction of certain functional groups. A functional group which can also serve for the introduction of further functional groups is an OH group. Suitable functionalisations which influence the separation properties, also called separation effectors, are known to the person skilled in the art. Examples are ionic groups for ion-exchange chromatography or hydrophobic groups for reversed-phase chromatography. Suitable derivatisation methods and suitable separation effectors are known to the person skilled in the art and are described in handbooks such as Packings and Stationary Phases in Chromatographic Techniques (K.K: Unger ed.; Marcel Dekker, New York and Basle (1990)) or Porous Silica (K.K. Unger ed.; Elsevier, Amsterdam, Oxford, New York (1979)). For separating media for thin-layer chromatography, derivatisation methods as disclosed in DE 27 12 113 and DE 28 09 137 are particularly suitable.

Preferred separation effectors are
amino groups
amino-functional groups
alkyl groups, in particular C8 and C18 groups
diol
cyano
phenyl
cation exchangers, such as, for example, SO₃²⁻

Amino-functional groups are alkyl groups which carry at least one amino group, for example aminopropyl.

A siloxane oligomer is in accordance with the invention a siloxane oligomer which contains at least silanol groups. Siloxane oligomers of this type are formed by co-condensation of silanes.

Oligomers typically have 2 to 200 siloxane units. Besides the silanol groups, the siloxane oligomers preferably also contain further functional groups or separation effectors, such as amino groups, alkyl groups, etc.

Siloxane oligomers of this type are known from EP 0 675 128, EP 0 716 127 and EP 0 716 128.

Suitable siloxane oligomers are linear oligomers, such as those of the formula X

R^{x}₃Si—[O—SiR^{x}₂]ₙ—O—SiR^{x}₃ X

or branched siloxane oligomers in which one or more Si units form a branching site. The example of a mono-branched compound is shown by formula XX

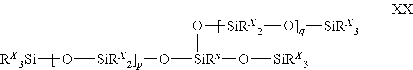

where, in the formulae X and XX,
R^{x} in each case, independently of one another, denotes

### H,

### OH,

straight-chain or branched alkyl having 1-20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms, which may be substituted by alkyl groups having 1-6 C atoms, where one or more R^{x} may be partially or fully substituted by halogens, in particular —F and/or —Cl, or partially by —OH, —OR′, —CN, —C(O)OH, —C(O)NR′₂, —SO₂NR′₂, —C(O)X, —SO₂OH, —SO₂X, —NO₂, —NR′₂, and where one or two non-adjacent carbon atoms of the R^{x} which are not in the α-position may be replaced by atoms and/or atom groups selected from the group —O—, —S—, —S(O)—, —SO₂—, —SO₂O—, —C(O)—, —C(O)O—, —N⁺R′₂—, —P(O)R′O—, —C(O)NR′—, —SO₂NR′—, —OP(O)R′O—, —P(O)(NR′₂)NR′—, —PR′₂═N— or —P(O)R′—, where R′═H, C₁- to C₆-alkyl, C₃- to C₇-cycloalkyl, unsubstituted or substituted phenyl and X may be halogen and where 1<=n<=200, 1<=p+q<=200 and where at least one R^{x}═OH.

Siloxane oligomers which are suitable in accordance with the invention can be prepared by condensation and at least partial hydrolysis of silanes of the formula Ia

SiX₄ Ia

where
X, independently of one another, can preferably be
OR^{a}
halogen, in particular Cl, Br, I
imidazole
N(R^{o})₂
   in which R^{a} is a C1 to C8 alkyl radical, in particular methyl, ethyl or isopropyl and
   R^{o} is methyl, ethyl or isopropyl.

Further suitable siloxane oligomers can be prepared by mixing water-soluble aminoalkylalkoxysilanes of the general formula I

R—Si(R¹)_{y}(OR¹*)_{3-y} I

preferably aminopropyltriethoxysilane, aminopropylmethyldiethoxysilane, aminopropyltrimethoxysilane or aminopropylmethyldimethoxysilane, with water-insoluble alkyltrialkoxysilanes of the general formula IIa

R²—Si(OR¹**)₃ IIa

preferably propyltrimethoxysilane, propyltriethoxysilane, methyltriethoxysilane, methyltrimethoxysilane, ethyltrimethoxysilane, ethyltriethoxysilane, isobutyltrimethoxysilane or isobutyltriethoxysilane, and/or water-insoluble dialkyldialkoxysilanes of the general formula III

AA′—Si(OR¹***)₂ III

preferably dimethyldimethoxysilane, dimethyldiethoxysilane, methylpropyldimethoxysilane or methylpropyldiethoxysilane,
and/or mixtures of water-insoluble alkyltrialkoxysilanes and dialkyldialkoxysilanes of the general formulae IIa and III,
where R is an amino-functional organic group,
R¹, R¹*, R¹** and R¹*** represent a methyl or ethyl radical,
R² represents a linear or cyclic or branched alkyl radical having 1 to 18 C atoms,
A represents an unbranched or branched alkyl radical having 1 to 3 C atoms and
A′ represents an unbranched or branched alkyl radical having 1 to 3 C atoms and 0<=y<=1,
addition of water to the mixture and adjustment of the pH of the reaction mixture to a value between 1 and 8 and removal of the alcohol already present and/or formed during the reaction.
Siloxane oligomers can furthermore be prepared by
mixing Q moles of water-soluble aminoalkylalkoxysilanes of the general formula I

R—Si(R¹)_{y}(OR¹*)_{3-y} I

preferably aminopropyltriethoxysilane, aminopropylmethyldiethoxysilane, aminopropyltrimethoxysilane or aminopropylmethyldimethoxysilane,
with M moles of water-insoluble alkylalkoxysilanes of the general formula IIb

R³—Si(OR¹**)₃ IIb

where R is an amino-functional organic group,
R¹, R¹* and R¹** represents a methyl or ethyl radical and
R³ represents a linear or cyclic or branched alkyl radical having 1 to 6 C atoms or a ureidoalkyl group of the general formula IV

NH₂—CO—NH—(CH₂)_{b} IV

where 1<=b<=6, preferably b=3,
and
0<=y<=1,
in the molar ratio 0<M/Q<=2,
addition of water to the mixture, adjustment of the pH of the reaction mixture to a value between 1 and 8 and removal of the alcohol already present and/or formed during the reaction.

Siloxane oligomers are furthermore obtainable by mixing water-soluble organosilanes of the general formula V

H₂N(CH₂)_{f}(NH)_{g}(CH₂)ᵢ—Si(CH₃)ₕ(OR⁰)₃₋ₕ V

in which 0<=f<=6, g=0 if f=0, g=1 if f>1, 0<=i<=6, 0<=h<=1 and R⁰ is a methyl, ethyl, propyl or isopropyl group, preferably aminopropyltriethoxysilane,
with organosilanes of the general formula VI

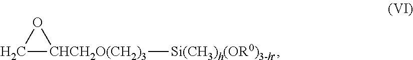

in which 0<=h<=1 and R⁰ represents a methyl, ethyl, propyl or isopropyl radical,

which are water-soluble, but are not stable in aqueous medium, preferably glycidyloxypropyltrimethoxysilane,
and/or of the general formula VII

H₂C═CR′—COO(CH₂)₃—Si(CH₃)ₕ(OR⁰₃₋ₕ VII

in which 0<=h<=1, R⁰ represents a methyl, ethyl, propyl or isopropyl radical and R′ represents a methyl or hydrogen radical,
preferably methacryloxypropyltrimethoxysilane,
and a water-insoluble organosilane of the general formula VIII

R″—Si(CH₃)ₕ(OR⁰)₃₋ₕ VIII

in which 0<=h<=1, R⁰ represents a methyl, ethyl, propyl or isopropyl radical and R″ represents a linear, branched or cyclic hydrocarbon radical having 1 to 18 C atoms,
preferably propyltrimethoxysilane,
in the molar ratio M=a/(b+c+d),
where a is the sum of the number of moles of the organosilanes of the formula V, b is the sum of the number of moles of the organosilanes of the formula VI and c is the sum of the number of moles of the organosilanes of the formula VII and d is the sum of the number of moles of the organosilanes of the formula VIII, where 0<=M<=3, in particular for M equals 0 where a equals 0 and/or c equals d equals 0 and b>=1 and preferably 0.5<=M<=3,
addition of a water/acid mixture to the mixture,
adjustment of the pH of the reaction mixture to a value between 1 and 8 and removal of the alcohol already present and/or formed during the reaction.

During the removal of the alcohol by distillation, water is preferably added to the extent that alcohol or alcohol/water mixture is removed from the reaction medium. Monobasic acids are particularly suitable for adjustment of the pH. Products prepared in this way do not liberate any further alcohols by hydrolysis, even on dilution with water, and have a flash point of significantly greater than 70° C.

A siloxane oligomer which can be prepared in the manner described above is, for example, Dynasylan® HS 2909, an oligomeric siloxane from Evonik.

A thin-layer plate according to the invention consists at least of a support plate and a sorbent layer, where the sorbent layer comprises at least one siloxane oligomer. If the sorbent layer does not comprise any further constituents which have effects on the separation properties, the separation properties are determined solely by the separation properties of the siloxane oligomers. These may contain, for example, alkyl groups, amino groups, ionic groups, etc. It is also possible for them to contain two or more different types of functional groups.

In a preferred embodiment, the sorbent layer additionally comprises inorganic and/or organic particles. For example, the particles may consist of the following materials:
SiO₂, for example in the form of silica gel or kieselguhr
aluminium oxide
TiO₂
acrylic/methacrylic-based polymers, for example GM/CGDMA glycidyl methacrylate/ethlene glycol dimethacrylate or HEMA hydroxyethyl metacrylate
polysaccharides, for example cellulose, agarose
hydrophilic polyvinyl ethers, for example BDMVE butanediol monovinyl ether or DVH divinylethleneurea

The sorbent layer of the thin-layer plate according to the invention preferably comprises SiO₂, for example in the form of kieselguhr or particularly preferably in the form of silica gel.

The particles typically have average particle sizes between 2 μm and 100 μm. The average particle diameter is preferably between 2 and 40 μm, particularly preferably between 2 and 15 μm. The particles may be spherical, irregularly shaped or crushed. Suitable particles have, for example, diameters between 4 and 8 μm or between 5 and 20 μm. Examples of suitable particles are silica gel 60 (4-8 μm) or silica gel 60 (5-20 μm) from Merck KGaA, Germany.

The sorbent layer may furthermore comprise further constituents, such as indicators or reflection enhancers. A frequently employed indicator is a fluorescence indicator, preferably magnesium tungstate, which absorbs in the UV at 254 nm (DE 28 16 574).

The particles may also be functionalised by means of separation effectors. In this case, the separation properties of the sorbent layer are determined both by the separation properties of the siloxane oligomers and also of the particles.

The thickness of the sorbent layer is typically between 1 μm and 5 mm, preferably between 10 μm and 500 μm.

The thin-layer plate according to the invention is produced by firstly preparing a mixture which comprises at least the siloxane oligomer and a solvent. Suitable solvents are those which at least partially dissolve the siloxane oligomer and in addition can be removed completely again at temperatures below 200° C. The choice of solvent depends on the solubility of the siloxane oligomer. Examples of suitable solvents are water, alcohols, such as ethanol or methanol, toluene and n-heptane or mixtures of two or more solvents. The solvent employed is preferably water if the siloxane oligomer is at least partially soluble therein.

The mixtures typically comprise between 1 and 50% by weight of solids component, preferably between 10 and 40% by weight of solids component. The solids component are all constituents of the mixture apart from the solvent. The solids component can be pure siloxane oligomer or mixtures of two or more siloxane oligomers or mixtures which also comprise particles and/or indicators in addition to at least one siloxane oligomer. The proportion of the siloxane oligomers in the solids component is between 0.1 and 100%, preferably between 1 and 40% (% by weight).

If further components, such as, for example, particles, indicators or other substances, are also to be added to the sorbent layer, these may be added to the mixture which comprises at least the siloxane oligomer and a solvent. Since, however, a reaction may occur directly with the, for example, particles, depending on the reactivity of the siloxane oligomers, two pre-mixtures are preferably prepared in this case. A pre-mixture which comprises at least the siloxane oligomer and a solvent and a pre-mixture which comprises the further components, for example the particles, in a solvent. The two pre-mixtures are then combined to form the final mixture, and this is then applied to the support. Alternatively, all components apart from the siloxane oligomer are firstly mixed, and the latter is only added to the mixture just before application to the support.

Methods for the application of a sorbent layer to supports for the production of thin-layer plates are known to the person skilled in the art. Suitable processes are, for example:
the mixture comprising siloxane oligomer and a solvent as well as further optional components is applied in the centre of the support; the support is subsequently rotated about the axis which passes through the application site, and which is aligned perpendicular to the surface of the support, so that a uniform liquid film forms. This application is also called spin coating.
the mixture comprising organosiloxane oligomer and a solvent as well as further optional components is sprayed onto the base support.
The application is carried out using a screen printing-like technique
The application is carried out by means of a doctor blade
Roller coating
Curtain coating
Dipping
Printing/dispenser processes, such as, for example, ink-jet

Further information on coating processes can be found in Liquid Film Coating, S. F. Kistler, P. M. Schweizer (editors), Chapman&Hall, London, 1997 or Modern Coating and Drying Technology, E. D. Cohen, E. B. Gutoff (editors), VCH, Weinheim 1992.

After the application, the coated support is preferably subjected to a temperature treatment. In this, it is typically stored at a temperature between 50 and 200° C. over a period between 30 and 200 minutes. This temperature treatment can be employed in order to effect further crosslinking of the siloxane oligomers with one another or with other components, for example with the particles. In addition, the thin-layer plate is dried in the process. In a preferred embodiment, the temperature treatment is carried out by means of a temperature gradient in which the temperature is increased continuously or stepwise to a temperature between 50 and 200° C., preferably to a temperature between 100 and 170° C., over a period of 30 to 200 minutes.

An illustrative production sequence is as follows:

1. Preparation of a silica-gel suspension in water with or without indicator
2. Evacuation in order to remove air bubbles, which would cause flaws during the coating
3. Addition of the siloxane oligomer, for example Dynasilan (type 2909/amino alkyl)

### 4. Coating

5. Temperature treatment for crosslinking and drying

The process according to the invention offers the advantage that for the most part organic solvents can be omitted, so that an explosion-protected environment is not necessary.

The siloxane oligomers crosslink by formation of covalent bonds. If particles containing suitable functional groups are added, such as, for example, silica particles containing Si—OH groups, covalent crosslinking via siloxane bridges/Si—O—Si is also generated by means of these particles.

This also enables the production of extremely stable layers, as also made clear in Example 2.

The thin-layer plates according to the invention can furthermore subsequently be functionalised by means of separation effectors. Methods for the introduction of separation effectors are known to the person skilled in the art. For example, this can be carried out via correspondingly functionalised silanes or siloxane oligomers.

It has been found that the thin-layer plates according to the invention have separation properties which can be modulated very broadly. On the one hand, the separation properties can be influenced by the functional groups of the siloxane oligomers, where a plurality of different functional groups which can have different separation effects, depending on the mobile phase, may also be present in parallel. If particles, such as, for example, silica particles, are additionally also present, these may have further functionalities which influence the separation properties.

For example, in particular in the case of the use of siloxane oligomers in combination with porous particles, specific functionalisation can be generated. If siloxane oligomers which are larger than the average pore diameter of the pores of the particles are used, the pores are for the most part not coated with siloxane oligomers. A network of siloxane oligomers which carries the functional groups of the siloxane oligomers only forms around the particles. By contrast, the pores of the particles have a different functionalisation.

For example, it is in this way possible using pure unfunctionalised SiO₂ particles and at least alkyl, for example amino/alkyl-functionalised siloxane polymers, to obtain comparable selectivities as on pure Si layers in the case of the use of a non-polar mobile phase (adsorption system/for example toluene), but the layer surface has a strongly hydrophobic character. Aqueous drops do not wet the layer, but instead remain thereon as drops. Examples of siloxane oligomers which are suitable for the production of plates for this application are those which carry C1 to C20 alkyl groups, such as, for example, methyl, ethyl, propyl and/or butyl, and optionally, for example, amino-functional groups.

Thin-layer chromatographic separation of a sample on a thin-layer plate according to the invention, i.e. the development of the thin-layer plate, is carried out under known conditions. Suitable mobile phases, for example acetonitrile, mixtures of acetonitrile and dichloromethane or mixtures of ethyl acetate, methanol and ammonia, are known to the person skilled in the art. The person skilled in the art is furthermore able to match the mobile phases to the respective separation problem. After development, the thin-layer plate is carefully dried in order to remove residues of the mobile phase. The developed plate is subsequently evaluated.

The evaluation can be carried out using methods known to the person skilled in the art, for example optically or by chemical derivatisation.

In a preferred embodiment, the evaluation of the thin-layer plate is carried out by bringing a sorbent layer area to be evaluated into contact with an eluent and feeding the eluate into an evaluation device.

In a preferred embodiment, the evaluation device is a mass spectrometer.

In a preferred embodiment, if the separation layer is hydrophobic, an eluent having a sufficiently high water content is used, so that the eluent is brought into contact with the separation layer by means of the pipette tip and remains there as a drop. The contact with the separation layer dissolves sample substance out of the separation layer. After an exposure time of typically 1 to 10 seconds, the eluent with the sample dissolved therein is taken up again by the pipette tip and can be transported into an evaluation unit. The eluate can be fed, for example, to a mass spectrometer in order to facilitate extremely precise evaluation of the thin-layer chromatogram.

Conventional Si layers cannot be evaluated using the aqueous elution described above, since aqueous solvent drops would penetrate directly into the sorbent layer. By contrast, on use of the thin-layer plates according to the invention which comprise unfunctionalised silica particles and siloxane oligomers which carry at least alkyl groups, drops of aqueous solvents remain on the sorbent layer, so that elution is possible.

In particular, the thin-layer plates according to the invention are therefore suitable for use in Advion's LESA® mode.

The thin-layer plates according to the invention comprising siloxane oligomers thus have the following advantages:
The siloxane oligomers which carry various functional groups which can be combined in various ways enable the separation properties to be adjusted in a very variable and optionally, depending on the mobile phase, modulatable manner.
The covalent crosslinking produces very stable layers.
The combination of the particles with the siloxane oligomers enables layers having customised functionalisation to be produced, for example hydrophilic properties in the pores in the case of hydrophobic layer surface, for example for use in LESA® mode.

Most of the binders usually employed (for example polyacrylic acids) are water-soluble, which may result in problems on use of aqueous mobile phases or derivatisation reagents. The layers according to the invention are water-stable and cannot be eluted due to the covalent crosslinking.

TLC layers which comprise water-soluble organic polymers (acrylic acid polymers) as binder can only be employed to a limited extent in applications in which large amounts of water or long exposure times are necessary. By contrast, the layers according to the invention do not have this limitation. An example is bioautographic detection on TLC plates [Journal of Chromatography A, 1218 (2011) 2684-2691]. In this, a bacterial culture which reacts to certain substances and enables detection via inhibition zones (for example bacillus subtilis for the detection of substances having an antibiotic action) is cultivated on the TLC plate. The high humidity necessary during the incubation time easily results in layer delamination in the case of conventional plates comprising polymer binder. In Example 8, it is shown how plates produced by the process described have absolute water stability at the same time as full water wettability.

Even without further comments, it is assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications mentioned above and below, in particular the corresponding application 13002009.2, filed on 17 Apr. 2013, is incorporated into this application by way of reference.

### EXAMPLES

### Example 1

### Production of TLC Plates by the Process Described Comprising 30% (% by Weight) of Organofunctionalised Siloxane, Based on the Amount of Silica Gel

120 g of water are initially introduced in a beaker. 67 g of silica gel 60, 5-20 μm, and 1.3 g of manganese-activated zinc silicate are added with stirring. The mixture is stirred for a further 20 min, and vacuum is subsequently applied for 40 min with constant shaking. 30 ml of organofunctionalised siloxane (Evonik Dynasilan HS2909/60% in water) are added, and the mixture is stirred for 15 min. The suspension is coated onto glass plates using a doctor blade and temperature-treated at 80° C. for 30 min followed by 140° C. for 30 min.

### Example 2

### Layer Stability

Owing to covalent bonds, significantly more stable layers can be produced compared with the prior art. The layer stability of plates in accordance with the process according to the invention is measured in comparison with a commercially available plate, with organic binder. To this end, a motor-driven drill which is placed onto the plate with a defined contact pressure is drilled into the layer, and the time taken for the drill to reach the glass surface of the support plate is measured.

Merck Millipore TLC KG 60 F254 glass plate with a layer thickness of 250 μm: 115 s

Plate in accordance with the process described comprising 30% of organofunctionalised siloxane (Evonik Dynasilan HS2909) with a layer thickness of 230 μm: 1200 s

### Example 3

### Direct Derivatisation of Sugars

A mixture of sugars is separated on a plate produced by the process according to the invention comprising 6% of organofunctionalised siloxane Evonik Dynasylan HS2909/aminoalkyl functionalisation). The sugars are subsequently reacted with the amino groups to give fluorescent compounds by heating at 150° C. for 5 min on the plate and are thus rendered visible or are derivatised (R. Klaus, W. Fischer, and H. E. Hauck, LC-GC, Vol. 13, Num. 10, 816-823).

FIG. 1 shows the developed thin-layer plates. Thin-layer plate A was produced by the process described, plate B is a Merck Millipore HPTLC Si60 NH₂ plate

Application volume: 2 μl

Mobile phase: development 1: water/ACN (30/70); development 2: ethyl acetate/pyridine/water/acetic acid/propionic acid (50/50/10/5/5)

Substances:

| Lane | Substance | Concentration | Solvent |
|---|---|---|---|
| 1 | D(+)- galactose | 0.5 mg/ml | water |
| 3 | Maltose monohydrate | 0.5 mg/ml | water |
| 5 | D(+)- arabinose | 0.5 mg/ml | water |
| 7 | D(+)- glucose | 0.5 mg/ml | water |
| 9 | D(−)- fructose | 0.5 mg/ml | water |
| 11 | D(−)- ribose | 0.5 mg/ml | water |
| 2, 4, 6, 8, 10, 12 | Mixture | 0.5 mg/ml | water |

### Example 4

The fact that, according to the model idea, functionalisation which gives rise to hydrophobic properties on the outside and hydrophilic properties in the particles is possible creates excellent suitability for LESA® (liquid extraction surface analysis).

Separation of steroids on a plate produced by the process described using the eluent ethyl acetate/toluene (95:5). LESA® extraction using the NanoMate® from Advion on the hydrophobic surface using methanol/water (50:50+0.1% of formic acid) and subsequent feed and evaluation using the mass spectrometer (Bruker Maxis™ high resolution mass spectrometer).

Substances: methyltestosterone (upper band), hydrocortisone (lower band) and Reichstein's substance S (middle band) in methanol

Concentration: 0.2 mg/ml

Application volume: 500 nl

FIG. 2 shows a photograph of the thin-layer plate at UV 254 nm

FIG. 3 shows the MS spectrum of hydrocortisone (lower band)

### Example 5

With reference to the separation of a mixture of three lipophilic dyes, developed using toluene, we show the following difference in the separation number (theoretically possible maximum number of substances which can be separated, determined from the peak width at half peak height) Merck Millipore TLC KG 60 F254 glass plate: separation number 11.2 Plate in accordance with the process described comprising 6% of organofunctionalised siloxane oligomer in water (Evonik Dynasilan HS2909): separation number 12.4.

This shows that the TLC plate according to the invention has better separation performance.

### Example 6

### Preparation of an Organofunctionalised Siloxane for the Production of Water-Wettable Layers

221 g of aminopropyltriethoxysilane (1 mol) are initially introduced, and 148.4 g of methyltriethoxysilane (0.8 mol) and 54 g of water are added dropwise with stirring, and the mixture is stirred for 30 min. A further 126 g of water are then added with stirring, and the mixture is stirred for 15 min. 114 g of HCl (32%) are subsequently added with stirring. When the addition is complete, the reaction mixture is heated using an oil bath (oil-bath temperature 75° C.) and distilled at a pressure of 135 mbar until the head temperature of the distillation apparatus rises above 50° C. The approx. 250 ml distilled off by then are fed back to the mixture as fresh water and distilled further. This is repeated once more and, after about 220 g have distilled off, the corresponding amount of fresh water is again added and the distillation is subsequently completed. The yield is 695 g, which corresponds to a concentration of organofunctionalised siloxane of 2.9 mol/litre or 31% (% by weight).

### Example 7

### Production of Water-Wettable Layers

Production of TLC plates by the process described comprising 12% (% by weight) of organofunctionalised siloxane, based on the amount of silica gel. 125 g of water are initially introduced in a beaker. 67 g of silica gel 60, 5-20 μm, and 1.3 g of manganese-activated zinc silicate are added with stirring. The mixture is stirred for a further 30 min, and vacuum is subsequently applied for 45 min with constant shaking. 24 ml of organofunctionalised siloxane (from Example 6) are added, and the mixture is stirred for 15 min. The suspension is coated onto glass plates using a doctor blade and treated with a temperature programme from 60° C. to 160° C. for 120 min.

### Example 8

### Water Stability

In order to test the water stability, the TLC plates are introduced completely into a water-filled vessel and it is measured when the layer begins to delaminate. For comparison, a commercially available TLC KG60 F₂₅₄ plate from Merck Millipore is also measured:

Merck Millipore TLC KG 60 F₂₅₄ glass plate: layer delamination after 20 minutes

Plate produced by the process described (from Example 7): after 2 weeks, no layer delamination detectable, experiment was not continued further.

1. Thin-layer plate a support and a sorbent layer, where the sorbent layer comprises at least one siloxane oligomer.

2. Thin-layer plate according to claim 1, characterised in that the sorbent layer additionally comprises inorganic and/or organic particles.

3. Thin-layer plate according to claim 1, characterised in that the siloxane oligomer contains C1 to C18 alkyl groups and/or amino groups.

4. Thin-layer plate according to claim 1, characterised in that the siloxane oligomer is a co-condensate of at least one water-soluble silane and at least one water-insoluble silane.

5. Thin-layer plate according to claim 1, characterised in that the thickness of the sorbent layer is between 10 and 500 μm.

6. Thin-layer plate according to claim 1, which can be produced by
a) preparation of a mixture at least comprising a siloxane oligomer and a solvent
b) application of the mixture from step b) to a support
c) temperature treatment of the thin-layer plate

7. Process for the production of thin-layer plates by
a) provision of a mixture which comprises at least one siloxane oligomer and a solvent
b) application of the mixture from step a) to a support
c) temperature treatment

8. Process according to claim 7, characterised in that step a) is carried out by
a1) preparation of a suspension of inorganic and/or organic particles in a solvent
a2) mixing of the suspension from step a) with a siloxane oligomer

9. Process according to claim 7, characterised in that the solvent used is water.

10. Process according to claim 7, characterised in that the mixture applied to the support in step b) comprises between 1 and 40% by weight of siloxane oligomer and between 60 and 99% by weight of SiO₂ particles in the solids component.

11. Process according to claim 7, characterised in that the temperature treatment is carried out by means of a temperature gradient in which the temperature is increased continuously or stepwise to a temperature between 50 and 200° C. over a period of 30 to 200 minutes.

12. Method for carrying out a thin-layer chromatographic separation having the following method steps
a) provision of a thin-layer plate according to claim 1
b) application of the samples to the thin-layer plate
c) development of the thin-layer plate using an eluent
d) removal of the eluent
e) evaluation of the thin-layer plate

13. Method according to claim 12, characterised in that the evaluation of the thin-layer plate is carried out by bringing a sorbent layer area to be evaluated into contact with an eluent and feeding the eluate into an evaluation device.

14. Method according to claim 13, characterised in that the evaluation device is a mass spectrometer.

15. A thin-layer plate according to claim 1, consisting of a support and a sorbent layer.
